(19) United States
(12) Patent Application Publication
(10) Pub. No.: US 2026/0037419 A1
(43) Pub. Date: Feb. 5, 2026

(54) MULTI-FACTOR CODE REVIEW PRIORITIZATION

(71) Applicant: Capital One Services, LLC, McLean, VA (US)

(72) Inventor: Aaron ATTAR, Dallas, TX (US)

(21) Appl. No.: 18/792,395

(22) Filed: Aug. 1, 2024

(51) Int. Cl. G06F 11/36

(52) U.S. Cl. CPC G06F 11/3698

(57) ABSTRACT

In some implementations, a code review system may identify a set of open code review requests that are each associated with a respective proposed change to source code stored in a code repository. The code review system may assign a respective priority to each open code review request, in the set of open code review requests, according to a respective set of attributes associated with each open code review request. The code review system may receive, from a reviewer device, a request to perform a code review workflow for an open code review request. The code review system may select an open code review request, in the set of open code review requests, associated with a highest priority. The code review system may manage the code review workflow for the open code associated with the highest priority.

### BACKGROUND

Code review, also known as peer code review, is a software quality assurance process in which one or more reviewers (which exclude the author) review source code and provide feedback that can suggest ways to improve the structure, performance, and maintainability of the source code and/or interaction or integration with other source code. Code reviews are usually performed before source code is integrated into a main branch of a codebase, but can also be performed for integrated source code to maintain code quality over time. During a code review, the one or more reviewers may consider issues such as whether the source code contains any logic errors, whether all cases are fully implemented, whether automated tests are sufficient, and/or whether the source code conforms to style guidelines, among other examples.

### SUMMARY

Some implementations described herein relate to a system for prioritizing code reviews. The system may include one or more memories and one or more processors communicatively coupled to the one or more memories. The one or more processors may be configured to identify a set of open code review requests that are each associated with a respective proposed change to source code stored in a code repository, wherein each open code review request, in the set of open code review requests, is associated with a respective set of attributes related to the respective proposed change to the source code stored in the code repository. The one or more processors may be configured to assign a respective priority to each open code review request, in the set of open code review requests, according to the respective set of attributes associated with each open code review request. The one or more processors may be configured to provide, to a reviewer device, information that indicates one or more of, one or more respective priorities assigned to one or more open code review requests, in the set of open code review requests, or one or more open code review requests, in the set of open code review requests, that are associated with a highest priority. The one or more processors may be configured to manage a code review workflow for an open code review request selected, by the reviewer device, from the set of open code review requests.

Some implementations described herein relate to a method for managing code reviews. The method may include identifying, by a code review system, a set of open code review requests that are each associated with a respective proposed change to source code stored in a code repository, wherein each open code review request, in the set of open code review requests, is associated with a respective set of attributes related to the respective proposed change to the source code stored in the code repository. The method may include assigning, by the code review system, a respective priority to each open code review request, in the set of open code review requests, according to the respective set of attributes associated with each open code review request. The method may include receiving, by the code review system and from a reviewer device, a request to perform a code review workflow for an open code review request, in the set of open code review requests. The method may include selecting, by the code review system, an open code review request, in the set of open code review requests, associated with a highest priority. The method may include managing, by the code review system, the code review workflow for the open code associated with the highest priority.

Some implementations described herein relate to a non-transitory computer-readable medium that stores a set of instructions. The set of instructions, when executed by one or more processors of a system, may cause the system to identify a set of open code review requests that are each associated with a respective proposed change to source code stored in a code repository, wherein each open code review request, in the set of open code review requests, is associated with a respective set of attributes related to the respective proposed change to the source code stored in the code repository. The set of instructions, when executed by one or more processors of the system, may cause the system to use a machine learning model to assign a respective priority to each open code review request, in the set of open code review requests, according to the respective set of attributes associated with each open code review request. The set of instructions, when executed by one or more processors of the system, may cause the system to manage a code review workflow for an open code review request, in the set of open code review requests, in accordance with the priority assigned to the open code review request.

### BRIEF DESCRIPTION OF THE DRAWINGS

FIG. 1 is a diagram of an example implementation associated with multi-factor code review prioritization, in accordance with some embodiments of the present disclosure.

FIG. 2 is a diagram illustrating an example of training and using a machine learning model in connection with multi-factor code review prioritization, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with multi-factor code review prioritization, in accordance with some embodiments of the present disclosure.

FIG. 5 is a flowchart of an example process associated with multi-factor code review prioritization, in accordance with some embodiments of the present disclosure.

### DETAILED DESCRIPTION

The following detailed description of example implementations refers to the accompanying drawings. The same reference numbers in different drawings may identify the same or similar elements.

Code review is an important process that is generally considered to be among the most effective quality assurance strategies in many software development patterns. For example, code review can be effective in enforcing coding standards, because reviewers can identify source code that does not meet coding standards for a software development team, which improves readability and consistency in a codebase. In addition, code review can facilitate knowledge and experience sharing, which is particularly useful for junior developers or developers who may be new to a software development team, can enable early defect detection to resolve errors before source code is merged into a main codebase, can spread knowledge of the current codebase, which may help developers to maintain a mental model of the overall software project and/or mitigate developer absences, and/or can improve self-editing because developers may be more likely to review their own code when knowing that someone else will be scrutinizing the code.

In some cases, a software development team may perform code review using informal or lightweight practices. For example, in an over-the-shoulder review, an author invites one or more peers or supervisors to review source code while sitting together at the same machine. In other examples, informal or lightweight code reviews may include pair programming, where two developers work together and continuously review code authored by each other, group code review meetings, where several developers review code together in a meeting, and/or email or chat reviews, where developers share code snippets via email or chat for quick feedback. While informal or lightweight code review practices may generally be effective in maintaining code quality and knowledge sharing, particularly in small software development teams, informal or lightweight code review practices can be inconsistent, tend to lack a documentation trail, and may be inefficient (e.g., because scheduling can be difficult and discussions may be lengthy).

Accordingly, in some cases, a software development team may perform tool-assisted code review, where developers use a code review utility to request code reviews through code review requests (also known as pull requests or merge requests), and developers interact with the code review utility to perform the code review. In particular, code review utilities generally offer various features to streamline and enhance the code review process, and to ensure that code quality, functionality, and maintainability are upheld. For example, code review utilities may facilitate collaboration and interaction among team members via a platform where reviewers can leave comments, suggest changes, and discuss specific lines or code sections. The collaboration features often include threaded conversations to keep discussions organized and contextually relevant. Additionally, code review utilities may support notifications and activity tracking to ensure that all participants are informed about updates and responses, which makes the review process more efficient and interactive. Furthermore, code review utilities often integrate with version control systems, which allows code changes to be automatically fetched, different source code versions to be compared, and approved changes to be easily merged into a codebase. Additional features that may be supported in a code review utility include highlighting differences between code versions, syntax highlighting and inline comments to further enhance readability and precision, and automated code analysis and integration with code pipelines. However, code review utilities generally lack features that enable reviewers to intelligently select what code to review, especially in larger organizations where there may be many open code review requests from many authors contributing proposed changes to a codebase. Instead, code review utilities typically implement techniques such as a first-in-first-out queue for open code review requests and/or allowing reviewers to autonomously select what code to review, which may result in urgent or sensitive code reviews being delayed, among other problems.

Some implementations described herein relate to a code review system that may intelligently prioritize open code requests according to multiple factors, such that open code review requests corresponding to proposed code changes may be triaged according to respective priorities. For example, when an author submits a code review request associated with a proposed code change to the code review system, the code review request may be associated with various attributes related to the proposed code change. For example, in some implementations, the attributes may include an identity of the author, the number of lines of code associated with the proposed code change, a date and/or time when the code review request was submitted, a most recent action associated with the proposed code change (e.g., related to previous comments or feedback for the proposed code change), and/or a development phase associated with the proposed code change (e.g., pre-commit or post-commit), among other examples. Accordingly, the various attributes may be input to a machine learning model configured to map the attributes to a respective priority, which may then be assigned to the code review request. Furthermore, in some implementations, the priority may be determined according to a particular code review parameter to be optimized (e.g., urgency, sensitivity, impact, and/or effort, among other examples). In this way, when a reviewer is initiating a code review workflow, the code review system may present information to the reviewer to indicate the respective priorities associated with open code review requests and/or to indicate the open code review requests with the highest priority, such that the reviewer can select a code review request to work on according to the priorities. Additionally, or alternatively, the code review system may assign a code review request to a reviewer in accordance with the priority (e.g., to prevent a situation where reviewers avoid high priority code review requests expected to involve significant effort). In this way, in addition to providing various features to streamline and enhance the code review process, the code review system may allow open code review requests to intelligently prioritized to ensure that important code review requests are not delayed.

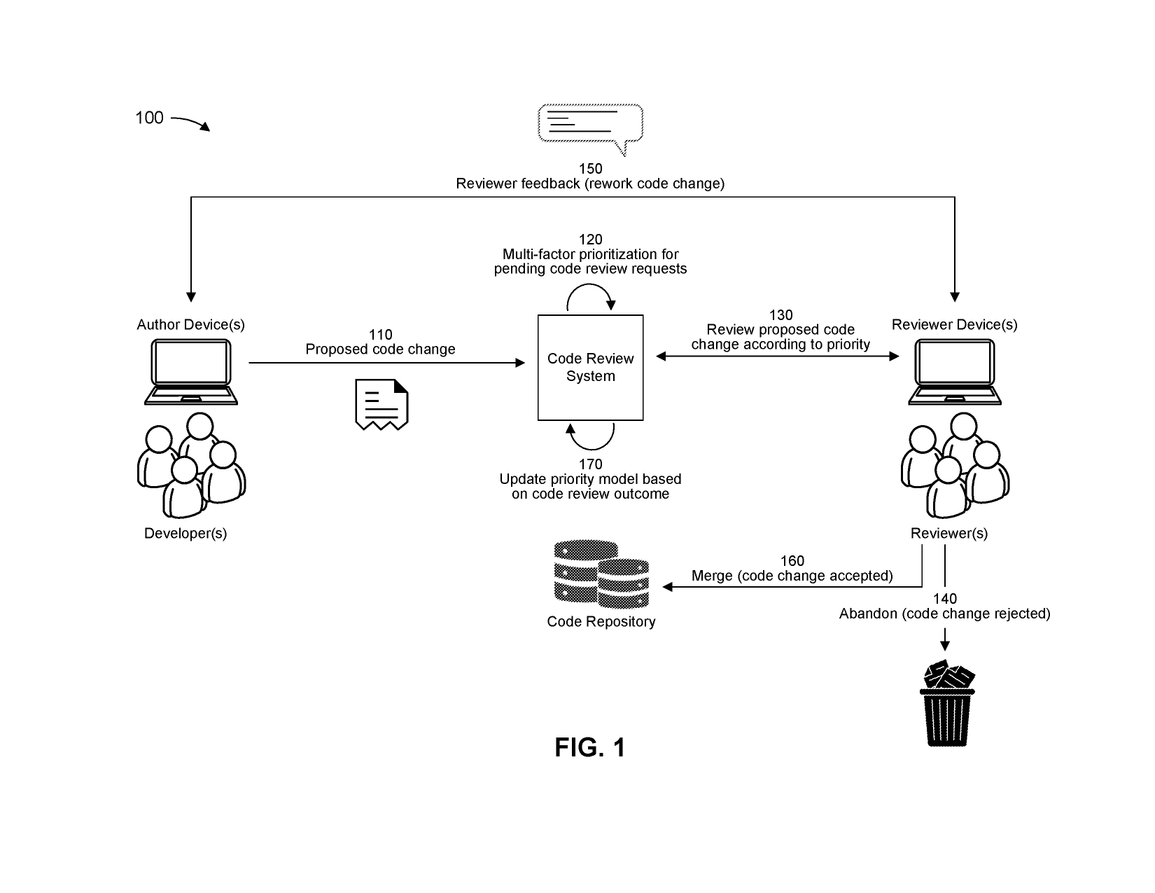

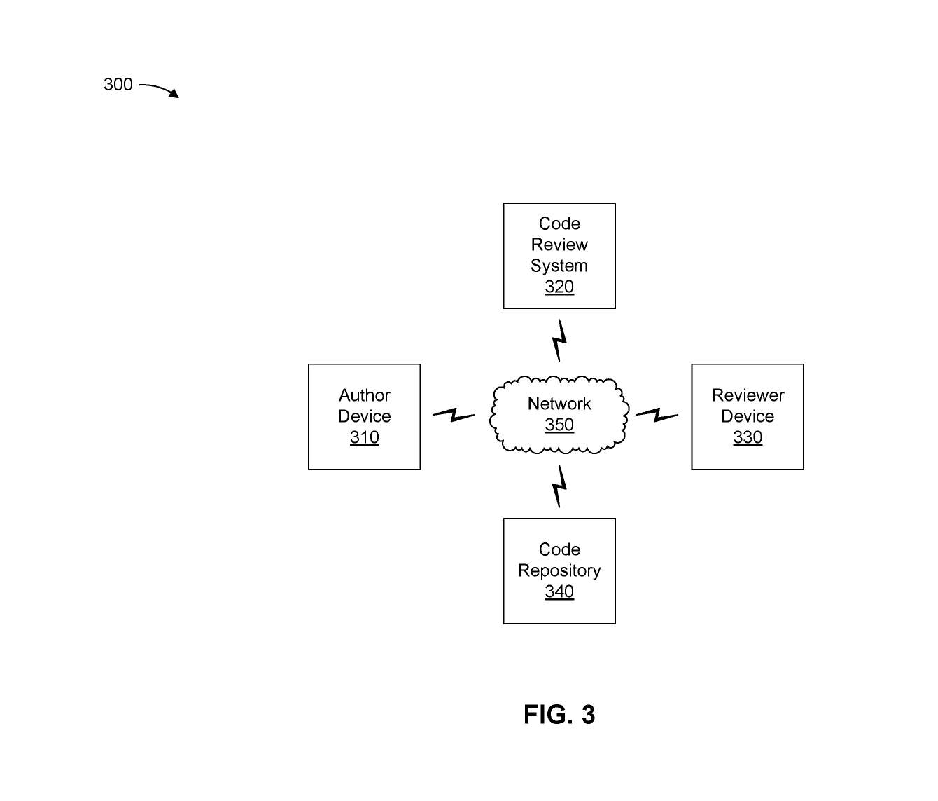

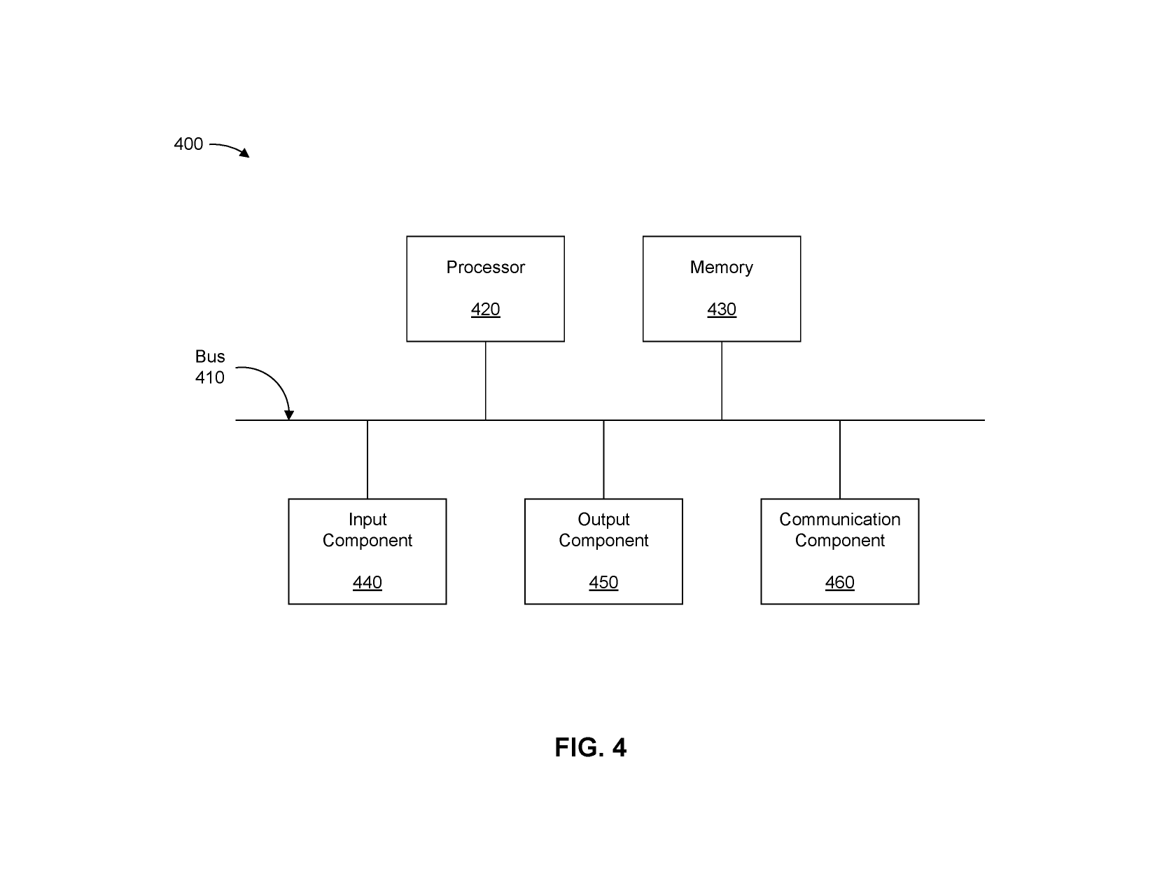

FIG. 1 is a diagram of an example implementation 100 associated with multi-factor code review prioritization. As shown in FIG. 1, example implementation 100 includes one or more author devices, a code review system, one or more reviewer devices, and a code repository. The one or more author devices, the code review system, the one or more reviewer devices, and the code repository devices are described in more detail in connection with FIG. 3 and FIG. 4.

As shown in FIG. 1, and by reference number 110, various developers on a software development team may each author source code locally on a respective author device, and may submit a code review request associated with a proposed code change to the code review system when the source code is ready to be reviewed. For example, the software development team may generally follow a software development lifecycle model that specifies various software development steps or phases and an order in which the various steps or phases occur. For example, in many software development lifecycle models (e.g., a waterfall model, an agile model, a rapid application development (RAD) model, or the like), a coding or implementation phase is typically preceded by a planning or design phase in which the software development team gathers requirements and determines a plan for how a software project will proceed. For example, before developers begin to write source code, a software development team may engage with stakeholders to gather requirements, understand the needs of the stakeholders, and define the project scope. Furthermore, the functional and non-functional requirements may be documented in a clear and structured manner (e.g., in a requirements specification document). The software development team may then create a project charter or roadmap that outlines the goals, objectives, scope, and deliverables of the software project, and may develop a project timeline with key milestones, deadlines, and deliverables. The software development team may then define a high-level architecture for the software project, including components and modules to be developed and interactions between the components and modules, and may create detailed design documents, such as unified modeling language (UML) diagrams, data flow diagrams, and/or entity-relationship diagrams, among other examples.

Accordingly, after the software development team has appropriately planned the software project, a coding or implementation phase may begin in which the developers on the software development team write the source code. For example, an integrated development environment (IDE) may be configured for each author device, where the IDE may include a source code editor, debugging utilities, connections to a version control system implemented via the code repository, and other libraries, software development kits (SDKs), and/or frameworks that may be needed to write the source code for the software project. The software project may be broken down into smaller, more manageable modules, and tasks may be assigned to developers on the software development team. Furthermore, as described herein, the IDE may be integrated with the code review system, which may be used to manage code review workflows in which reviewers conduct code reviews to identify issues, improve code quality, and ensure that source code adheres to coding standards and guidelines before the source code is merged with or otherwise added to a codebase in the code repository.

Accordingly, when a developer has written source code that is ready for code review, the developer may use the author device to submit a code review request to the code review system. For example, the code review request is generally associated with a proposed change to source code stored in the code repository, and may be associated with a set of attributes that relates to the proposed code change and provides the eventual reviewer(s) sufficient information to effectively review the proposed code change. For example, in some implementations, the set of attributes associated with the code review request may include an identifier for a developer of the proposed code change, a brief and descriptive title that summarizes the proposed code change, a more detailed description of the proposed code changes (e.g., including a reason why the proposed code change was made, design decisions, a potential impact on the codebase, and/or any other relevant context), information identifying related issues, tickets, or user stories in a project management tool, a list or summary of the files and/or functions that were modified, added, or deleted, a description of test cases, testing instructions, and/or results from any automated tests that the developer has already run, information identifying any new or changed dependencies introduced by the proposed code change, verification that the proposed code change adheres to coding standards and conventions for the software project, visual aids such as screenshots to help reviewers understand user interface changes or complex logic, one or more reviewers who should review the proposed code change, including any specific people with expertise in a certain area of the codebase, a deadline for the code review to be completed, information indicating a size of the proposed code change (e.g., a number of lines of source code to be reviewed), and/or previous comments or votes for the proposed code change, among other examples. In this way, the attributes associated with the code review request may provide clarity and context to the code review request, which may help reviewers to understand and evaluate the proposed code change and to provide constructive feedback on the proposed code change. Furthermore, as described herein, the various attributes associated with the code review request may enable the code review system to assign an appropriate priority to the code review request.

For example, as shown by reference number 120, the code review system may perform a multi-factor prioritization for pending or open code review requests based on the set of attributes associated with each code review request. In some implementations, the code review system may perform the multi-factor prioritization to assign a priority to each code review request when the code review request is received from an author device. Additionally, or alternatively, the code review system may periodically identify open code review requests or identify open code review requests when a triggering event occurs (e.g., a quantity of open code review requests in a code review request queue satisfies a threshold), and may assign and/or update the priorities to the code review requests in accordance with a current state of the code review request queue. For example, in some implementations, the set of attributes associated with a code review request (or a subset of the attributes associated with the code review request) may be input to a machine learning model configured to map the set of attributes to a priority. Furthermore, in some implementations, the mapping implemented by the machine learning model may be tuned according to a parameter to be optimized. For example, in some implementations, the mapping may be optimized according to a severity to prioritize reviewing proposed code changes related to the most severe issues, an urgency to prioritize reviewing urgent code changes first, an impact to prioritize reviewing code changes that have the most overall value or impact on the software project, and/or an effort to prioritize reviewing the code changes that require the least time or the most time first.

Accordingly, in some implementations, one or more code review parameters to be optimized (e.g., severity, urgency, impact, and/or effort, among other examples) may be assigned relative weights, such that the mapping implemented by the machine learning model (e.g., weights between neurons) may be adjusted to optimize the appropriate code review parameters based on the relative weights. For example, in some implementations, the priorities may be assigned to the open code review requests based on urgency-related variables, such as deadlines (e.g., where requests associated with features or fixes that are needed for imminent releases or associated with imminent deadlines receive a higher priority) or milestone dependencies (e.g., where code changes that are critical to achieve project milestones or unblock subsequent work items receive a higher priority). Additionally, or alternatively, in some implementations, the priorities may be assigned to the open code review requests based on impact-related variables, such as changes requested by customers or clients or related to a service level agreement (SLA) receiving a higher priority or code changes having a direct impact on revenue generation or cost savings receiving a higher priority. Additionally, or alternatively, the priorities may be assigned to the open code review requests based on severity-related variables, such as code changes for critical bugs that affect stability, security, or major functionality receiving a higher priority or issues that significantly impact a user experience or user-facing features receiving a higher priority. Other attributes that may impact the priority of a proposed code change may include effort-related variables, such as a complexity and/or size of the proposed code change (e.g., prioritizing large or complex changes to allow more time for thorough review and testing, deprioritizing small and isolated changes that are deemed less critical, and/or prioritizing small code changes that can be reviewed quickly to reduce a backlog or unblock other work items).

As further shown in FIG. 1, and by reference number 130, the code review system may receive a request to perform a code review workflow from a reviewer device that is operated by a code reviewer. Accordingly, the code review system may present, to the reviewer device, information that enables the reviewer to select an open code review request according to the priorities associated with the open code review requests. For example, in some implementations, the code review system may provide a user interface to display a status of a code review queue that includes various open code review requests, where each open code review request is associated with a set of relevant attributes that include the priority assigned to the respective code review request. Accordingly, the code review system may present information that indicates the priorities assigned to the various open code review requests and/or may present information that indicates the open code review requests associated with the highest priorities. Additionally, or alternatively, the information presented to the reviewer device may be filtered or sorted according to a set of criteria (e.g., a project name, a developer role, assigned or requested reviewers, a time when the code review request was created or last updated, a current review state, and/or a current testing state, among other examples). Furthermore, in some implementations, the criteria used to filter or sort the open code review requests may include the priorities associated with the open code review requests (e.g., to view all open code review requests associated with a moderate to high priority, and/or to sort open code review requests from a highest priority to a lowest priority or vice versa, among other examples).

In this way, when the reviewer operating the reviewer device selects an open code review request, the code review system may then manage a code review workflow for the code review request. Alternatively, in some implementations, the code review system may assign a code review request to the reviewer (e.g., to ensure that high priority changes are reviewed first), and then manage the code review workflow for the code review request. For example, during the code review workflow, the reviewer may examine the proposed code change for functionality, readability, maintainability, and/or adherence to coding standards, to identify bugs, security vulnerabilities, and/or performance issues, and/or to ensure that the proposed code change aligns with the architectural guidelines of the software project. In some cases, as shown by reference number 140, the reviewer may determine that the proposed code change does not satisfy code quality requirements, and may reject the proposed code change. In such cases, the proposed code may be abandoned and the developer may be instructed to start over or the development task may be assigned to a different team member. Alternatively, as shown by reference number 150, the reviewer may provide comments and/or suggestions to improve the code change and/or ask questions for clarification, or the developer and the reviewer may discuss the feedback in back-and-forth exchanges to clarify points or debate the best approach to improve the code change. In such cases, the developer may address the feedback by making necessary changes (e.g., rewriting code sections, adding tests, and/or making other suitable modifications suggested by the reviewer) and update the code review request in the code review system. The updated code review request may then be reviewed again to ensure that all feedback has been adequately addressed, and the code review workflow may include multiple iterations of review and feedback until the reviewer is satisfied with the proposed code change.

Accordingly, as shown by reference number 160, the proposed code change may be merged with the codebase managed in the code repository when the reviewer approves the proposed code change. Additionally, or alternatively, multiple reviewers may be required to approve the proposed code change before the proposed code change is accepted and merged. At this point, any final automated checks may be executed to ensure that the approved version of the code change passes all tests, and the code change may be merged into the main codebase in the code repository (e.g., the developer via the developer device or automatically by the code review system after the code change is approved). In some implementations, after the code change is merged with the main codebase in the code repository, the code change may be built, tested, and deployed to a staging environment or a production environment according to a code pipeline implemented for the software project. Post-deployment, the software may be monitored to ensure that the code changes did not introduce any new issues in the production environment. Furthermore, in some cases, the software development team may hold a retrospective meeting to discuss what went well and what could be improved in the code review process. As shown by reference number 170, the code review system may obtain a set of observations related to the outcome from the code review workflow (e.g., whether a code change was approved or rejected, how feedback was addressed before the code change was approved, and/or metrics related to performance of the code change post-deployment, among other examples), and the observations related to the outcome from the code review workflow may be used to update the machine learning model to improve the priority mapping for subsequent code review requests.

As indicated above, FIG. 1 is provided as an example. Other examples may differ from what is described with regard to FIG. 1.

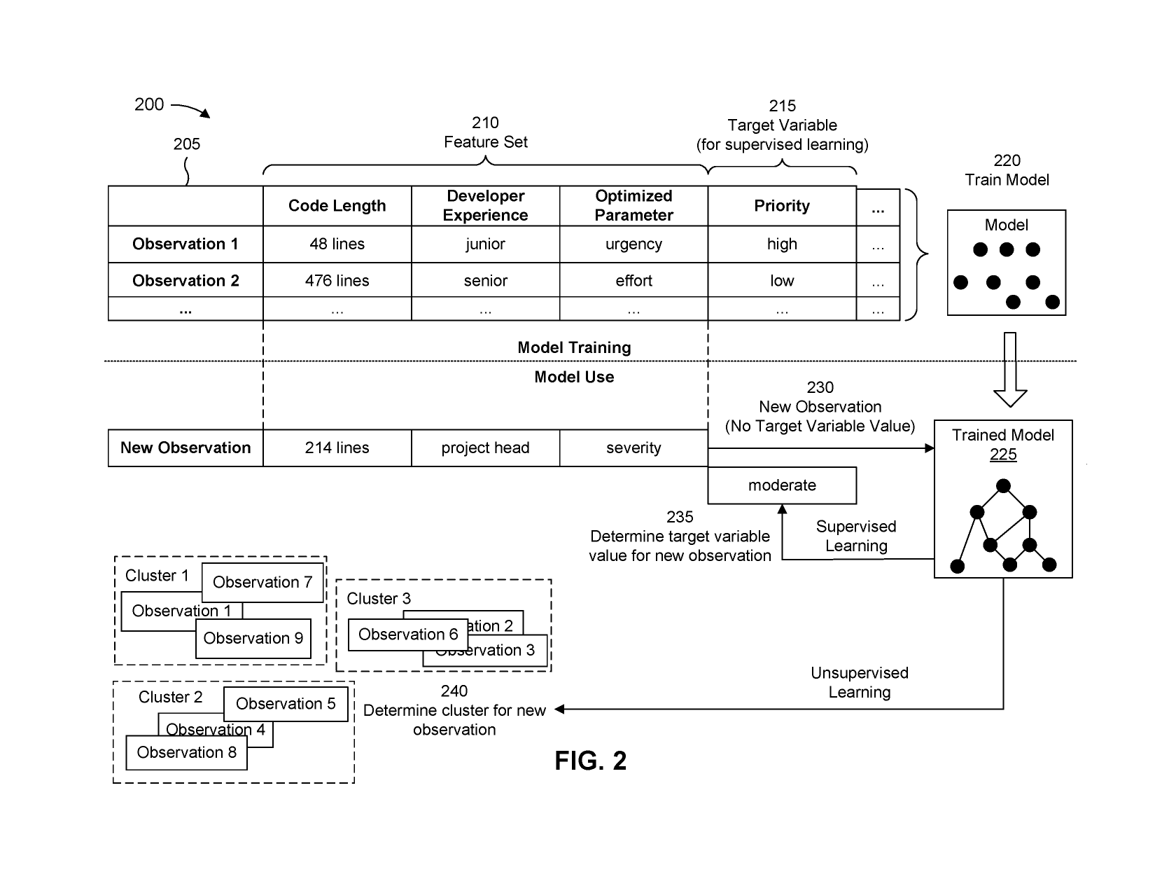

FIG. 2 is a diagram illustrating an example 200 of training and using a machine learning model in connection with multi-factor code review prioritization. The machine learning model training and usage described herein may be performed using a machine learning system. The machine learning system may include or may be included in a computing device, a server, a cloud computing environment, or the like, such as the code review system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the code review system, one or more author devices, one or more reviewer devices, a code repository, and/or one or more systems associated with a code pipeline, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the code review system, one or more author devices, one or more reviewer devices, a code repository, and/or one or more systems associated with a code pipeline. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of code length, a second feature of developer experience, a third feature of optimized parameter, and so on. As shown, for a first observation, the first feature may have a value of 48 lines, the second feature may have a value of junior, the third feature may have a value of urgency, and so on. These features and feature values are provided as examples, and may differ in other examples. For example, the feature set may include one or more of the following features: a deadline, a milestone dependency, a customer request status, an SLA status, a stability status, a security status, a functionality, a code dependency, a library or framework update, a risk, an experimental feature status, reviewer availability, reviewer expertise, reviewer workload, assigned reviewers, team capacity, a cross-team dependency, a strategy alignment, a relevance to an innovation initiative, and/or a relevance to compliance or regulatory requirements, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is priority, which has a value of “high” for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical results associated with code review workflows.

As shown by reference number 230, the machine learning system may apply the trained machine learning model 225 to a new observation, such as by receiving a new observation and inputting the new observation to the trained machine learning model 225. As shown, the new observation may include a first feature of 214 lines, a second feature of project head, a third feature of severity, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of moderate for the target variable of priority for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, prioritizing the code review request associated with the new observation. The first automated action may include, for example, assigning the code review request associated with the new observation to a reviewer that is initiating a code review workflow.

As another example, if the machine learning system were to predict a value of low for the target variable of priority, then the machine learning system may provide a second (e.g., different) recommendation (e.g., deprioritizing the code review request associated with the new observation) and/or may perform or cause performance of a second (e.g., different) automated action (e.g., excluding the code review request associated with the new observation from a user interface for a code review queue when a reviewer views open code review requests).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., high priority), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., low priority), then the machine learning system may provide a second (e.g., different) recommendation, such as the second recommendation described above, and/or may perform or cause performance of a second (e.g., different) automated action, such as the second automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include an outcome for a code review workflow associated with the code review request and metrics related to performance of the code change after being deployed to a staging or production environment.

In this way, the machine learning system may apply a rigorous and automated process to assign priorities to code review requests associated with proposed source code changes. The machine learning system may enable recognition and/or identification of tens, hundreds, thousands, or millions of features and/or feature values for tens, hundreds, thousands, or millions of observations, thereby increasing accuracy and consistency and reducing delay associated with assigning priorities to code review requests associated with proposed source code changes relative to requiring computing resources to be allocated for tens, hundreds, or thousands of operators to manually assign priorities to code review requests using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an author device 310, a code review system 320, a reviewer device 330, a code repository 340, and a network 350. Devices of environment 300 may interconnect via wired connections, wireless connections, or a combination of wired and wireless connections.

The author device 310 may include one or more devices capable of receiving, generating, storing, processing, and/or providing information associated with source code to be reviewed in one or more code review workflows, as described elsewhere herein. The author device 310 may include a communication device and/or a computing device. For example, the author device 310 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The code review system 320 may include one or more devices capable of receiving, generating, storing, processing, providing, and/or routing information associated with multi-factor prioritization for open code review requests, as described elsewhere herein. The code review system 320 may include a communication device and/or a computing device. For example, the code review system 320 may include a server, such as an application server, a client server, a web server, a database server, a host server, a proxy server, a virtual server (e.g., executing on computing hardware), or a server in a cloud computing system. In some implementations, the code review system 320 may include computing hardware used in a cloud computing environment.

The reviewer device 330 may include one or more devices capable of receiving, generating, storing, processing, and/or providing information associated with a code review workflow to review source code associated with an open code review request in accordance with a multi-factor priority assigned to the open code review request, as described elsewhere herein. The reviewer device 330 may include a communication device and/or a computing device. For example, the reviewer device 330 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The code repository 340 may include one or more devices capable of receiving, generating, storing, processing, and/or providing information associated with source code that has been reviewed in one or more code review workflows and approved for merging with a codebase managed via the code repository, as described elsewhere herein. The code repository 340 may include a communication device and/or a computing device. For example, the code repository 340 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the code repository 340 may store a codebase that may be merged with source code that has been reviewed and approved in one or more code review workflows, as described elsewhere herein.

The network 350 may include one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with multi-factor code review prioritization. The device 400 may correspond to the author device 310, the code review system 320, the reviewer device 330, and/or the code repository 340. In some implementations, the author device 310, the code review system 320, the reviewer device 330, and/or the code repository 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

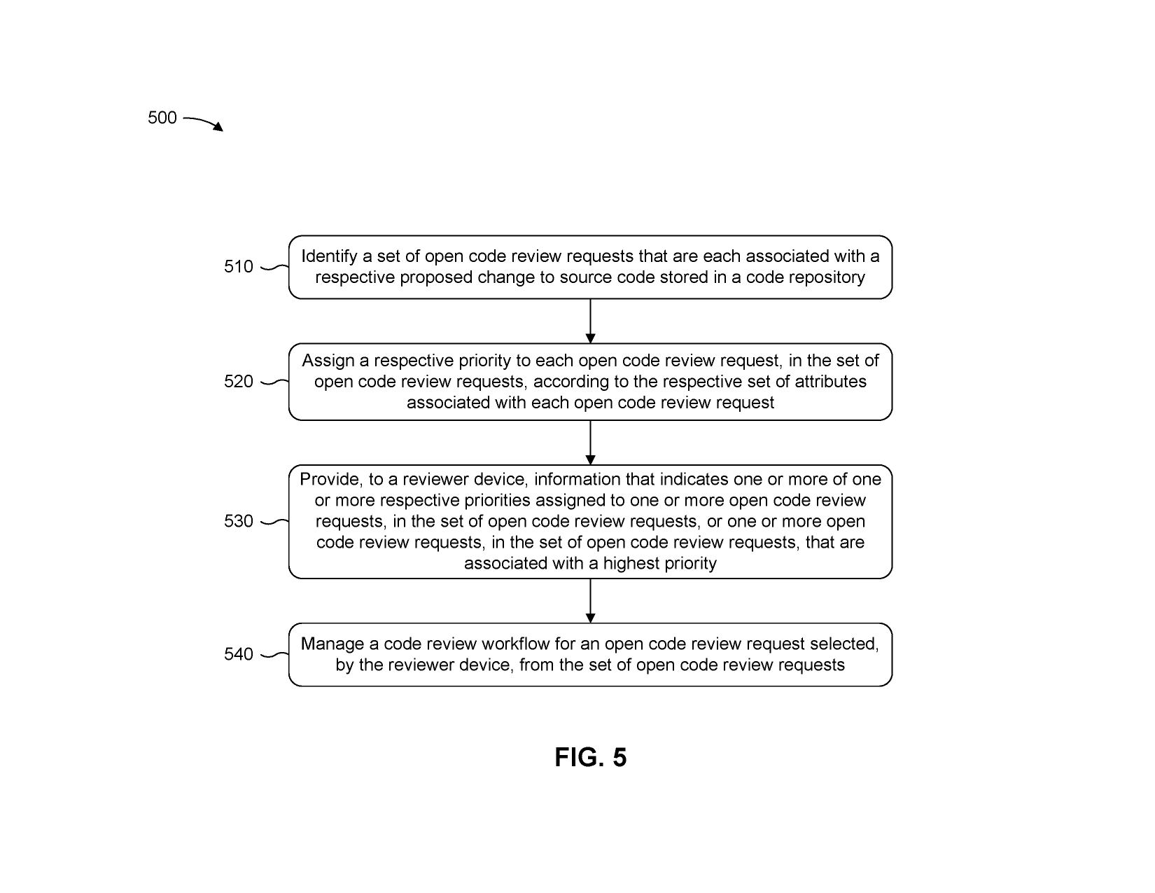

FIG. 5 is a flowchart of an example process 500 associated with multi-factor code review prioritization. In some implementations, one or more process blocks of FIG. 5 may be performed by the code review system 320. In some implementations, one or more process blocks of FIG. 5 may be performed by another device or a group of devices separate from or including the code review system 320, such as the author device 310, the reviewer device 330, and/or the code repository 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include identifying a set of open code review requests that are each associated with a respective proposed change to source code stored in a code repository (block 510). For example, the code review system 320 (e.g., using processor 420 and/or memory 430) may identify a set of open code review requests that are each associated with a respective proposed change to source code stored in a code repository, as described above in connection with reference numbers 110 and 120 of FIG. 1. In some implementations, each open code review request, in the set of open code review requests, is associated with a respective set of attributes related to the respective proposed change to the source code stored in the code repository. As an example, the set of attributes associated with a code review request may indicate an author of the proposed code change, a review type (e.g., pre-commit or post-commit), a review number and version, a creation or last update time, a current review state, and/or a test state, among other examples.

As further shown in FIG. 5, process 500 may include assigning a respective priority to each open code review request, in the set of open code review requests, according to the respective set of attributes associated with each open code review request (block 520). For example, the code review system 320 (e.g., using processor 420 and/or memory 430) may assign a respective priority to each open code review request, in the set of open code review requests, according to the respective set of attributes associated with each open code review request, as described above in connection with reference number 120 of FIG. 1. As an example, the code review system may input the attributes associated with a code review request to a machine learning model that maps the attributes associated with the code review request to a priority (e.g., according to relative weights associated with target parameters to be optimized), and the machine learning model may output the priority of the code review request.

As further shown in FIG. 5, process 500 may include providing, to a reviewer device, information that indicates one or more of one or more respective priorities assigned to one or more open code review requests, in the set of open code review requests, or one or more open code review requests, in the set of open code review requests, that are associated with a highest priority (block 530). For example, the code review system 320 (e.g., using processor 420 and/or memory 430) may provide, to a reviewer device, information that indicates one or more of: one or more respective priorities assigned to one or more open code review requests, in the set of open code review requests, or one or more open code review requests, in the set of open code review requests, that are associated with a highest priority, as described above in connection with reference numbers 120 and 130 of FIG. 1. As an example, a reviewer may access the code review system to view open code review requests, and a user interface may display a code review queue that includes a set of open code review requests that indicates the priorities assigned to the various open code review requests and/or indicates the open code review requests with the highest priorities.

As further shown in FIG. 5, process 500 may include managing a code review workflow for an open code review request selected from the set of open code review requests (block 540). For example, the code review system 320 (e.g., using processor 420 and/or memory 430) may manage a code review workflow for an open code review request selected from the set of open code review requests, as described above in connection with reference numbers 130, 140, 150, and 160 of FIG. 1. As an example, the reviewer may review the proposed code change for functionality, readability, maintainability, and/or adherence to coding standards, to identify bugs, security vulnerabilities, and/or performance issues, and/or to ensure that the proposed code change aligns with the architectural guidelines of the software project, and the proposed code change may be rejected or approved accordingly. Alternatively, the reviewer may leave feedback for the author and/or collaborate with the author to improve the code change before the code change is eventually rejected or approved for merging with a main codebase.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIG. 1. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for prioritizing code reviews, the system comprising:
one or more memories; and
one or more processors, communicatively coupled to the one or more memories, configured to:
identify a set of open code review requests that are each associated with a respective proposed change to source code stored in a code repository,
wherein each open code review request, in the set of open code review requests, is associated with a respective set of attributes related to the respective proposed change to the source code stored in the code repository;
assign a respective priority to each open code review request, in the set of open code review requests, according to the respective set of attributes associated with each open code review request;
provide, to a reviewer device, information that indicates one or more of:
one or more respective priorities assigned to one or more open code review requests, in the set of open code review requests, or
one or more open code review requests, in the set of open code review requests, that are associated with a highest priority; and
manage a code review workflow for an open code review request selected, by the reviewer device, from the set of open code review requests.

2. The system of claim 1, wherein the one or more processors, to assign the respective priority to each open code review request, in the set of open code review requests, are configured to:
provide the respective set of attributes associated with each open code review request as an input to a machine learning model; and
determine the respective priority to assign to each open code review request, in the set of open code review requests, according to an output from the machine learning model.

3. The system of claim 2, wherein the machine learning model maps the respective set of attributes associated with each open code review request to the respective priority based on relative weights assigned to a set of code review parameters to be optimized.

4. The system of claim 3, wherein the set of code review parameters include an urgency, a severity, an impact, and an effort associated with each open code review request.

5. The system of claim 2, wherein the one or more processors are further configured to:
obtain a set of observations associated with the code review workflow for the open code review request; and
update the machine learning model according to the set of observations associated with the code review workflow.

6. The system of claim 1, wherein the information provided to the reviewer device indicates a status associated with a code review queue that includes the set of open code review requests.

7. The system of claim 6, wherein the information that indicates the status associated with the code review queue is filtered according to a set of criteria that includes the priorities assigned to each open code review request, in the set of open code review requests.

8. The system of claim 6, wherein the information that indicates the status associated with the code review queue is sorted according to the priorities assigned to each open code review request, in the set of open code review requests.

9. A method for managing code reviews, comprising:
identifying, by a code review system, a set of open code review requests that are each associated with a respective proposed change to source code stored in a code repository,
wherein each open code review request, in the set of open code review requests, is associated with a respective set of attributes related to the respective proposed change to the source code stored in the code repository;
assigning, by the code review system, a respective priority to each open code review request, in the set of open code review requests, according to the respective set of attributes associated with each open code review request;
receiving, by the code review system and from a reviewer device, a request to perform a code review workflow for an open code review request, in the set of open code review requests;
selecting, by the code review system, an open code review request, in the set of open code review requests, associated with a highest priority; and
managing, by the code review system, the code review workflow for the open code associated with the highest priority.

10. The method of claim 9, wherein assigning the respective priority to each open code review request, in the set of open code review requests, comprises:
providing the respective set of attributes associated with each open code review request as an input to a machine learning model; and
determining the respective priority to assign to each open code review request, in the set of open code review requests, according to an output from the machine learning model.

11. The method of claim 10, wherein the machine learning model maps the respective set of attributes associated with each open code review request to the respective priority based on relative weights assigned to a set of code review parameters to be optimized.

12. The method of claim 10, further comprising:
obtaining a set of observations associated with the code review workflow for the open code review request; and
updating the machine learning model according to the set of observations associated with the code review workflow.

13. A non-transitory computer-readable medium storing a set of instructions, the set of instructions comprising:
one or more instructions that, when executed by one or more processors of a system, cause the system to:
identify a set of open code review requests that are each associated with a respective proposed change to source code stored in a code repository,
wherein each open code review request, in the set of open code review requests, is associated with a respective set of attributes related to the respective proposed change to the source code stored in the code repository;
use a machine learning model to assign a respective priority to each open code review request, in the set of open code review requests, according to the respective set of attributes associated with each open code review request; and
manage a code review workflow for an open code review request, in the set of open code review requests, in accordance with the priority assigned to the open code review request.

14. The non-transitory computer-readable medium of claim 13, wherein the one or more instructions, that cause the system to use the machine learning model to assign the respective priority to each open code review request, in the set of open code review requests, cause the system to:
provide the respective set of attributes associated with each open code review request as an input to the machine learning model; and
determine the respective priority to assign to each open code review request, in the set of open code review requests, according to an output from the machine learning model.

15. The non-transitory computer-readable medium of claim 14, wherein the machine learning model maps the respective set of attributes associated with each open code review request to the respective priority based on relative weights assigned to a set of code review parameters to be optimized.

16. The non-transitory computer-readable medium of claim 15, wherein the set of code review parameters include an urgency, a severity, an impact, and an effort associated with each open code review request.

17. The non-transitory computer-readable medium of claim 14, wherein the one or more instructions further cause the system to:
obtain a set of observations associated with the code review workflow for the open code review request; and
update the machine learning model according to the set of observations associated with the code review workflow.

18. The non-transitory computer-readable medium of claim 13, wherein the one or more instructions further cause the system to:
receive, from a reviewer device, a request to perform the code review workflow; and
select the open code review request for the code review workflow based on the open code review request being associated with a highest priority.

19. The non-transitory computer-readable medium of claim 13, wherein the one or more instructions further cause the system to:
provide, to a reviewer device, information that indicates one or more of:
one or more respective priorities assigned to one or more open code review requests, in the set of open code review requests, or
one or more open code review requests, in the set of open code review requests, that are associated with a highest priority; and
receive, from the reviewer device, an input selecting the open code review request to perform the code review workflow for the open code review request.

20. The non-transitory computer-readable medium of claim 19, wherein the information provided to the reviewer device is filtered or sorted according to the respective priorities assigned to each open code review request, in the set of open code review requests.
